(19) United States
(12) Patent Application Publication
(10) Pub. No.: US 2002/0189577 A1
(43) Pub. Date: Dec. 19, 2002

(54) Apparatus for deactivating one or more cylinders of an internal combustion engine

(76) Inventor: Myoung-Jin Kim, Suwon-city (KR)

Correspondence Address: Pennie & Edmonds, LLP, 3300 Hillview Avenue, Palo Alto, CA, 94304, US

(21) Appl. No.: 10/171,670

(22) Filed: Jun. 14, 2002

(30) Foreign Application Priority Data
Jun. 15, 2001 (KR) 2001-0033825

(51) Int. Cl. F02B 77/00

(52) U.S. Cl. 123/198 F

(57) ABSTRACT

The present invention provides an apparatus for deactivating one or more cylinders of an internal combustion engine. The apparatus comprises: a surge tank being provided with a plurality of chambers, said chambers temporarily storing air being provided from a throttle body; an air distributor for selectively providing air to said chambers of said surge tank; and an intake manifold connected to the chambers of the surge tank.

### FIELD OF THE INVENTION

The present invention relates to an internal combustion engine, and more particularly, to an apparatus for selectively deactivating one or more cylinders of an internal combustion engine.

### BACKGROUND OF THE INVENTION

Generally, in an internal combustion engine, fuel is burned in a combustion chamber, and the internal combustion engine is operated using power that is generated when the burned fuel expands. An internal combustion engine is provided with a plurality of cylinders. Deactivation of one or more cylinders during low engine load and allowing the remaining cylinders to carry the load increases fuel economy. Such multi-cylinder engines capable of cylinder deactivation have been produced. Typically, in the case of an in-line 4 cylinder engine, two cylinders are deactivated; in the case of a V-6, three cylinders (one bank) are deactivated. Here, “deactivating a cylinder” means inhibiting any of intake of an air/fuel mixture, combustion, and exhaust of combustion gas, while allowing reciprocating motion of a piston.

Typically, the deactivation of cylinders is performed by an apparatus for disabling the camshaft such that the intake valve is maintained in a closed state. However, cylinder deactivation apparatus according to the prior art require an apparatus for disabling the camshaft, and therefore, manufacturing costs increase.

### SUMMARY OF THE INVENTION

In a preferred embodiment of the present invention, an apparatus for deactivating one or more cylinders of an internal combustion engine comprises a surge tank, an air distributor, and an intake manifold. The surge tank inclues a plurality of chambers that temporarily store air provided from a throttle body. The air distributor selectively provides air to the chambers of the surge tank. The intake manifold is connected to the chambers of the surge tank. Preferably, the surge tank is divided into two chambers by a dividing wall, and the air distributor is disposed between the throttle body and the surge tank.

In a further preferred embodiment, the air distributor comprises a first plate, a second plate, a rotator, and a plurality of air distributing tubes, wherein the first plate is provided with a plurality of openings equidistantly located on a circular line formed at a constant radius from a center thereof. The second plate is rotatably disposed proximate to said first plate, the second plate being provided with a plurality of openings located at positions corresponding to the openings of the first plate and one additional opening located on the circular line midway between any two of the equidistantly located openings. The rotator rotates the second plate, and the plurality of air distributing tubes provide communication between the openings of the first plate and the chambers of the surge tank.

More preferably, the rotator comprises a rotating rod, a connecting rod, and an actuator. One end portion of the rotating rod is connected to the second plate; the connecting rod is hingedly connected to the other end portion of the rotating rod; and the actuator moves the connecting rod such that the rotating rod rotates. It is preferable that the actuator is a solenoid.

It is further preferable that the first plate is provided with two openings, and that the second plate is provided with two openings corresponding to the openings of the first plate and one additional opening located midway between the two openings on the circular line formed at a constant radius from the center thereof.

In a further alternative embodiment of the invention, a housing communicates with an air intake. An air distributing member is disposed in the housing. At least first and second distributing tubes communicate with the housing and with a surge tank. The surge tank is divided into first and second chambers, each chamber communicating with one of the tubes. Each chamber communicates via an intake manifold with a selected number of cylinders less than all cylinders of the engine. Preferably, the air distributing member comprises first and second plates. The first plate defines at least first and second openings, each opening being aligned with one of the distributing tubes. The second plate is disposed between the first plate and the distributing tubes and is rotatable between a first position permitting air flow to all distributing tubes and a second position blocking air flow to at least one distributing tube.

In a further preferred embodiment, the second plate defines a first set of two openings alignable with the first and second distributing tubes and a second set of one opening rotatably displaced from the first set and alignable with one distributing tube. The apparatus may also comprise a rotating rod secured to the second plate, a connecting rod cooperating with the rotating rod, a connection bar pivotably connected to the connecting rod, and a solenoid acting on the connection bar. Actuation of the solenoid rotates the second plate to a predetermined orientation.

### BRIEF DESCRIPTION OF THE DRAWINGS

The accompanying drawings, which are incorporated in and constitute a part of the specification, illustrate an embodiment of the invention, and, together with the description, serve to explain the principles of the invention, wherein:

FIG. 1 is a schematic view of the cylinder deactivation apparatus according to a preferred embodiment of the present invention;

FIG. 2 is a plane view of a rotator of the cylinder deactivation apparatus of FIG. 1;

FIG. 3 shows the state of first and second circular plates during full engine load; and

FIG. 4 shows the state of first and second circular plates during low engine load.

### DETAILED DESCRIPTION OF THE PREFERRED EMBODIMENTS

Hereinafter, a preferred embodiment of the present invention will be described in detail with reference to the accompanying drawings.

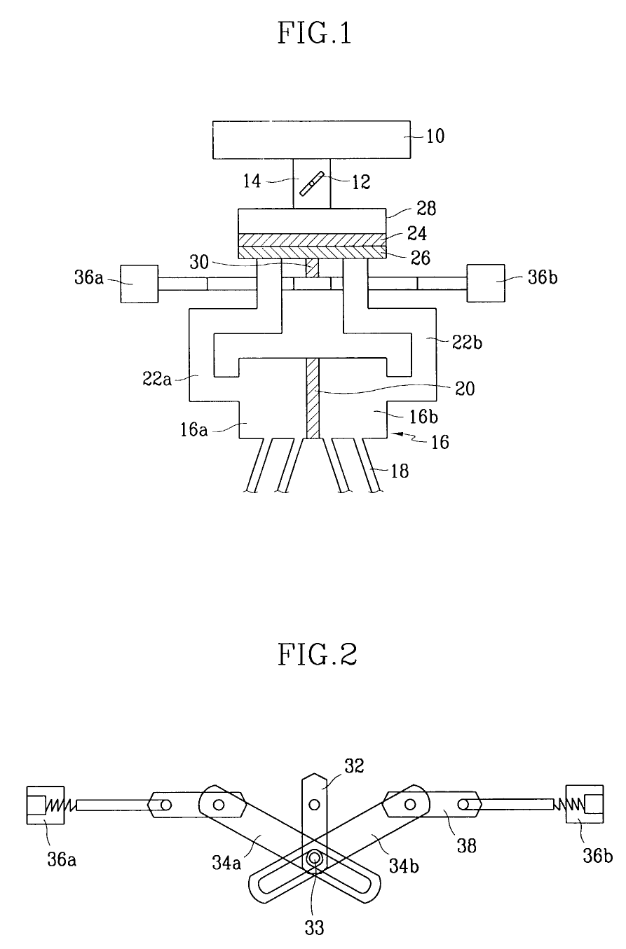

As shown in FIG. 1, an air supply system of an internal combustion engine comprises an air cleaner 10, a throttle body 14 defining a throttle bore where a throttle valve 12 for regulating an amount of intake air is mounted, a surge tank 16 for temporarily storing air provided from the throttle body 14, and an intake manifold 18 for providing air of the surge tank 16 into combustion chambers (not shown).

An apparatus for deactivating one or more cylinders according to the invention therefore preferably comprises the surge tank 16, which is divided into two chambers 16a and 16b by a dividing wall 20. Air is respectively provided into the chambers 16a and 16b from the throttle body 14 through air distributing tubes 22a and 22b. Also, the intake manifold 18 is connected to the surge tank 16 so that air is supplied to the combustion chambers.

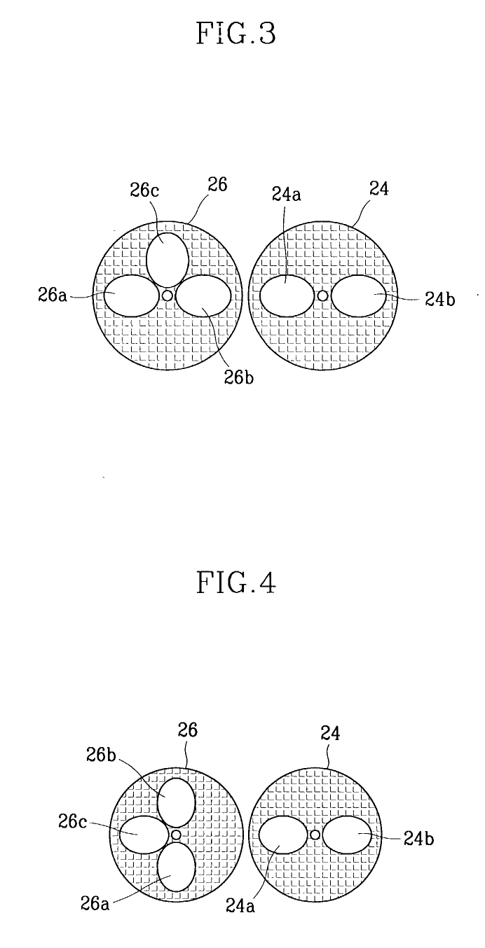

The cylinder deactivation apparatus according to the present invention further includes an air distributing member for distributing air between chambers 16a and 16b of the surge tank 16. The air distributing member includes a first circular plate 24 and a second circular plate 26. The first circular plate 24 is fixedly mounted to a housing 28, and the second circular plate 26 is rotatable with respect to the first circular plate 24 and is disposed to closely contact the first circular plate 24. Two circular holes 24a and 24b are formed on the first circular plate 24, as shown in FIGS. 3 and 4.

The second circular plate 26, as shown in FIGS. 3 and 4, is provided with three circular holes 26a, 26b, and 26c. Positions of the holes 26a and 26b correspond to positions of the holes 24a and 24b of the first circular plate 24, and the hole 26c is located on a line perpendicular to a line connecting centers of the holes 24a and 24b when the second circular plate 26 is in a position for operating all cylinders, at the same distance from the center of the plate as the others.

If the second circular plate 24 rotates with respect to the first circular plate, the holes 24a and 24b are selectively opened or closed. The air distributing tubes 22a and 22b are connected to a lower portion of the housing 28 at positions corresponding to the positions of the holes 24a and 24b of the first circular plate 24.

The second circular plate 26 is closely contacted to the first circular plate 24 such that air does not leak therebetween when air is supplied to the chambers 16a and 16b of the surge tank 16 through the air distributing tubes 22a and 22b. The first circular plate 24 is mounted to the housing 28 such that air passing through the throttle body 14 flows into the holes 24a and 24b.

As shown in FIG. 2, a rotator for rotating the second circular plate 26 comprises a rotating rod 32 with one end fixedly connected to a central axis of the second circular plate 26 through a post 30, a pair of connecting rods 34a and 34b that are hingedly connected to a hinge post 33 on the other end of the rotating rod 32. Solenoids 36a and 36b are hingedly connected to connecting rods 34a and 34b. Because the rotating rod 32 is fixed to the central axis of the second circular plate 26 through the post 30, the second circular plate 26 rotates with the rotating rod 32.

The connecting rods 34a and 34b are connected to the rotating rod 32 such that if one of the connecting rods 34a or 34b moves more than a certain amount, the rotating rod 32 rotates. That is, the connecting rods 34a and 34b are provided with slots, and if one of the connecting rods 34a or 34b moves an amount greater than the length of the slot with respect to the hinge post 33, the rotating rod 32 rotates.

The solenoids 36a and 36b are hingedly connected to the connecting rods 34a and 34b. When the solenoids are located far from the connecting rods, connecting bars 38 can be disposed between the connecting rods and the solenoids. The solenoids 36a and 36b are actuated to move the connecting rods 34a and 34b according to signals indicating engine load.

Operation of the cylinder deactivation apparatus according to the present invention will be explained hereinafter.

During full engine-load, the second circular plate 26 is controlled to rotate such that the holes 26a and 26b of the second circular plate 26 are overlapped with the holes 24a and 24b of the first circular plate 24, as shown in FIG. 3. Thus, air is supplied to both the chambers 16a and 16b of the surge tank 16 through the holes 24a, 24b, 26a, and 26b, and the air distributing tubes 22a and 22b. The air supplied to the chambers 16a and 16b is supplied to all combustion chambers through the intake manifold 18. All cylinders are then activated.

During low engine load, current is applied to only one of the solenoids 36a and 36b. If current is supplied to solenoid 36b and not to solenoid 36a, the connecting rod 34b is pulled by the solenoid action, and it slides along its slot on the hinge post 33 of the rotating rod 32. Once the end of the slot of the connecting rod 34b reaches the hinge post 33 of the rotating rod 32, continued pulling of the solenoid causes the rotating rod 32 to rotate. Therefore, the second circular plate 26 that is fixed to the rotating rod 32 through the post 30 rotates to a position as shown in FIG. 4.

As the connecting rod 34b causes the rotating rod 32 to rotate, the connecting rod 34a pivots at its hinge point with the solenoid 36a as the hinge post 33 moves along the slot of the connecting rod 34a.

When the second circular plate 26 is rotated to a point as shown in FIG. 4, air is supplied to the chamber 16a of the surge tank 16 through the air distributing tube 22a and the circular holes 24a and 26c. The air distributing tube 22b is closed by the second circular plate 26. Therefore, cylinders connected to the chamber 16a of the surge tank 16 are provided with air, and cylinders connected to the chamber 16b of the surge tank 16 are not provided with air and are therefore deactivated.

If a current is applied only to solenoid 36a, the second circular plate 26 rotates in a direction opposite to the direction resulting in the alignment of FIG. 4. In this case, air is supplied to the chamber 16b through the air distributing tube 22b and the circular holes 24b and 26c. The air distributing tube 22a is closed by the second circular plate 26. Therefore, cylinders connected to the chamber 16b of the surge tank 16 are provided with air, and cylinders connected to the chamber 16a of the surge tank 16 are not provided with air and are therefore deactivated.

It is preferable that fuel is not injected into the cylinders to which air is not supplied.

As stated above, the cylinder deactivation apparatus according to the present invention can deactivate one or more of cylinders without an apparatus for disabling a camshaft. Therefore, the manufacturing costs decrease and the manufacturing process can be simplified.

Further, because opening/closing valve timing control, which has a serious affect on efficiency of an internal combustion engine, is not needed, the internal combustion engine can be optimally controlled while deactivating cylinders.

What is claimed is:

1. An apparatus for deactivating one or more cylinders of an internal combustion engine, said apparatus comprising:
a surge tank provided with a plurality of chambers, said chambers temporarily storing air being provided from a throttle body;
an air distributor for selectively providing air to said chambers of said surge tank; and
an intake manifold connected to the chambers of the surge tank.

2. The apparatus of claim 1, wherein said surge tank is divided into two chambers by a dividing wall.

3. The apparatus of claim 1, wherein said air distributor is disposed between said throttle body and said surge tank.

4. The apparatus of claim 1, wherein said air distributor comprises:
a first plate provided with a plurality of openings equidistantly located on a circular line formed at a constant radius from a center thereof;
a second plate rotatably disposed proximate to said first plate, said second plate provided with a plurality of openings located at positions corresponding to the openings of said first plate and one additional opening located on the circular line midway between any two of the equidistantly located openings;
a rotator for rotating the second plate; and
a plurality of air distributing tubes communicating the openings of the first plate with the chambers of the surge tank.

5. The apparatus of claim 4, wherein said rotator comprises:
a rotating rod, one end portion of which is connected to the second plate;
a connecting rod hingedly connected to the other end portion of the rotating rod; and
an actuator for moving the connecting rod such that the rotating rod rotates.

6. The apparatus of claim 6, wherein said actuator is a solenoid.

7. The apparatus of claim 4, wherein the first plate is provided with two openings, and the second plate is provided with two openings corresponding to the openings of the first plate and one additional opening located midway between the two openings on a circular line formed at a constant radius from a center thereof.

8. An apparatus for deactivating one or more cylinders of an internal combustion engine, comprising:
a housing communicating with an air intake;
an air distributing member disposed in said housing;
at least first and second distributing tubes communicating with said housing through said air distributing member;
a surge tank communicating with said distributing tubes, wherein said surge tank is divided into first and second chambers, each chamber communicating with one of said tubes, and each chamber communicating via an intake manifold with a selected number of cylinders less than all cylinders.

9. The apparatus of claim 8, wherein said air distributing member comprises:
a first plate defining at least first and second openings, each said opening being aligned with one of said distributing tubes; and
a second plate disposed between the first plate and said distributing tubes, wherein said second plate is rotatable between a first position permitting air flow to all distributing tubes and a second position blocking air flow to at least one distributing tube.

10. The apparatus of claim 9, wherein said second plate defines a first set of two openings alignable with said first and second distributing tubes and a second set of one opening rotatably displaced from said first set and alignable with one said distributing tube.

11. The apparatus of claim 9, further comprising:
a rotating rod secured to the second plate;
a connecting rod cooperating with the rotating rod;
a connection bar pivotably connected to the connecting rod; and
a solenoid acting on the connection bar;
whereby actuation of the solenoid rotates the second plate to a predetermined orientation.
